(19) United States
(12) Patent Application Publication
(10) Pub. No.: US 2026/0242123 A1
(43) Pub. Date: Aug. 20, 2026

(54) HOME-COMPOSTABLE SINGLE-SERVE BEVERAGE CONTAINER

(71) Applicant: NOTTINGHAM SPIRK DESIGN ASSOCIATES, Cleveland, OH (US)

(72) Inventors: John S. McKenzie, Aurora, OH (US); Trevor L. Jackson, Kirtland, OH (US); Jess P. Carlson, Painesville, OH (US); Aaron M. Searles, Columbus, OH (US); Micah A. Levitsky, Columbus, OH (US)

(73) Assignee: NOTTINGHAM SPIRK DESIGN ASSOCIATES, Cleveland, OH (US)

(21) Appl. No.: 19/539,779

(22) Filed: Feb. 13, 2026

Related U.S. Application Data
(60) Provisional application No. 63/758,394, filed on Feb. 14, 2025.

(51) Int. Cl. B65D 85/804; A47G 19/22

(52) U.S. Cl. CPC B65D 85/8046; A47G 19/2205; A47G 19/2272; B65D 85/8061; B65D 2543/00092

(57) ABSTRACT

A home-compostable single-serve beverage container designed to be used in single-serve beverage systems. The single-serve beverage container includes a cup component, a filter component, and a top cover. The cup component comprises a compostable material, with an exterior surface, a bottom, and an opening located distally from the bottom. The filter component has an opening and a bottom surface, and comprises a biodegradable material positioned within the cup component, the bottom surface located proximal to the bottom of the cup component. The top cover is affixed to the cup component adjacent to the opening, and also is comprised of a biodegradable material. The exterior surface of the cup component comprises at least one of a visual or textural feature communicating a compostable property of the single-use beverage container.

### CROSS-REERENCE TO RELATED APPLICATIONS

This application claims priority to U.S. Provisional Patent Application Serial No. 63/758,394, filed February 14, 2025, and titled HOME-COMPOSTABLE SINGLE-SERVE BEVERAGE CONTAINER, the disclosure of which is incorporated by reference in its entirety herein.

### BACKGROUND

The present disclosure relates to compostable, biodegradable, single use and/or single serving beverage containers.

Single-serving coffee machines have become prevalent in office and home settings throughout the world. A user may select from among a variety of types of coffee, tea, and other beverages that may be used to brew a single serving of their beverage of choice. One such type of single-serving coffee machine utilizes a cup or pod like container that may be inserted into the machine. The size and strength of the beverage may be selected and brewing may occur over one to two minutes later, resulting in freshly brewed cup of coffee or other beverage. The spent cup or pod is then removed from the coffee machine and disposed of, typically in the trash.

The packaging of single-serve beverage containers may be in a variety of different forms, including, for example and without limitation, pods, cups, packets, pouches, etc., in accordance with the type of beverage machine. For example purposes, the term cup or pod may be used interchangeably hereinafter to refer to such single-serve containers. To ensure freshness, the ground coffee, tea, chocolate, etc., is generally hermetically sealed within the pod, usually with a nitrogen (or similar) atmosphere to prevent spoilage. In some implementations, the pod may include a filter housing the beverage material to prevent such material, e.g., coffee grounds, from exiting the pod during brewing operations.

The pod or cup generally includes a top, which a needle or tube of the coffee machine pierces to inject steam or water into the interior of the pod or cup, and a base portion in which a filter is placed holding the beverage material. A bottom of the base portion is typically pierced to allow the beverage to exit the pod after brewing. In most such implementations, the filter holding the beverage material does not extend to contact the interior bottom of the base portion, preventing the piercing component from damaging or extending through the filter.

The base portion of the pod, such as a K-CUP® coffee pod utilized by the KEURIG brand of coffee machines, is typically constructed of a plastic material, providing an oxygen barrier, which in conjunction with the top seal, prevents spoilage of the contents. The base or cup portion of the K-CUP® is typically formed via vacuum or injection molding using a polymer material, e.g., polyethylene, polystyrene, etc. Unfortunately, this type of material is typically not conducive to the environment. In some instances, the single-use nature of these pods inhibits recycling of the polymers, as the integral filter and beverage material (e.g., coffee grounds, tea leaves, chocolate mix, etc.) must be removed prior to reclamation of the plastic materials.

There has been a movement in recent years to utilize recyclable materials or biodegradable materials in packaging at the consumer level. In particular, home composting has become more prevalent with eco-aware consumers. Home composting, in contrast to industrial composting, allows for the breakdown of materials without specific heating, moisture, or other controlled environmental factors. In some instances, the ability of the consumer to readily identify packaging and materials that may be composted is inhibited by the use of advanced materials that mimic known plastics. For example, a product might be home compostable, but the manufactured product too closely resembles another material that would not be considered appropriate for composting. Alternatively, the compostable product may be constructed of materials that may only be commercially composted, e.g., constructed of materials that require specific environmental conditions to be artificially maintained to degrade the material. Further, home compostable materials are generally unattractive to the consumer, resembling poorly constructed packaging or materials.

Accordingly, there is a need to provide the appropriate appearance to convey the biodegradable, compostable nature of a package while maintaining product freshness, package strength, and structural compatibility.

### BRIEF SUMMARY

In accordance with some embodiments, there is provided a home-compostable single-serve beverage container that is designed to be used in single-serve beverage systems. The single-serve beverage container includes a cup component, a filter component, and a top cover. The cup component comprises a compostable material, with an exterior surface, a bottom, and an opening located distally from the bottom. The filter component has an opening and a bottom surface, and comprises a biodegradable material positioned within the cup component, the bottom surface located proximal to the bottom of the cup component. The top cover is affixed to the cup component adjacent to the opening, and also is comprised of a biodegradable material. The exterior surface of the cup component comprises at least one of a visual or textural feature communicating a compostable property of the single-use beverage container.

According to an embodiment, the cup component further comprises an outer layer and at least one inner layer. This multi-layer construction allows for enhanced structural integrity while maintaining compostability and providing an effective oxygen barrier to preserve beverage freshness. Further, such construction negates the need for secondary packaging of the single-serve beverage container.

According to an embodiment, the outer layer comprises a first biodegradable material and the at least one inner layer comprises a second biodegradable material different from the first biodegradable material. This combination of different biodegradable materials enables optimization of both the visual compostability indicators on the exterior and the functional barrier properties on the interior.

According to an embodiment, the outer layer and the at least one inner layer are home compostable. This ensures that the entire container can be disposed of in a home composting environment without requiring industrial composting facilities, thereby increasing accessibility for eco-conscious consumers.

According to an embodiment, the second biodegradable material is an oxygen-barrier. This provides protection for the beverage contents from oxidation and degradation while maintaining the compostable nature of the container.

According to an embodiment, the cup component further comprises a rim located distally from the bottom of the cup component, the rim having a substantially planar surface extending radially outward from the exterior surface of the cup component. This rim structure facilitates secure attachment of the top cover and provides compatibility with standard single-serve beverage brewing systems.

According to an embodiment, the top cover is circumferentially affixed to a top surface of the rim. This circumferential attachment creates a hermetic seal that maintains freshness of the beverage contents and prevents contamination.

According to an embodiment, the rim further comprises a lower surface having at least one ridge formed thereon. These ridges provide additional structural support to the rim and may facilitate bonding between multiple layers of the cup component.

According to an embodiment, the cup component further comprises a ledge positioned circumferentially on the interior surface of the cup component between the rim and the bottom surface of the cup component. This ledge provides a mounting surface for the filter component and may ensure proper positioning within the cup component.

According to an embodiment, the filter component is affixed to the interior surface of the cup component below the ledge. This positioning maintains a predetermined distance between the filter bottom and the cup bottom, preventing damage to the filter during the brewing process.

According to an embodiment, the filter component is affixed to the interior surface of the cup component above the ledge. This alternative positioning allows the filter to extend radially outward on the ledge surface, further preventing beverage material from bypassing the filter during brewing operations.

According to an embodiment, the compostable material of the cup component comprises at least one of BioPBS FD92 resin, BWC BF 90A resin, Ecopond Flex 162 resin, HCPT-1 triple laminate, HCFD-2 duplex laminate, or Torise TRBF90 resin. These specific materials provide structural properties for single-serve beverage containers while meeting home composting requirements.

According to an embodiment, the compostable material of the cup component comprises at least one of a biodegradable bioplastic material, a biodegradable plastic material, a biodegradable paper material, or a biodegradable plant-based material. This broad range of material options allows for flexibility in manufacturing while ensuring compostability.

According to an embodiment, the bottom surface of the filter component is positioned a predetermined distance from the bottom of the cup component. This spacing creates a buffer zone that allows the brewing system to puncture the cup bottom without damaging the filter component.

According to an embodiment, the predetermined distance forms a gap between the filter component and the bottom of the cup component. This gap provides a collection area for brewed beverage to exit the container after passing through the filter.

According to an embodiment, the exterior surface of the cup component comprises a matte finish, a satin finish, a dull finish, a distressed finish, or a scuffed finish. These surface finishes provide tactile and visual cues that communicate the natural, compostable nature of the container to consumers.

According to an embodiment, the exterior surface of the cup component comprises a textured pattern. This textured pattern enhances the visual communication of compostability and provides a distinctive appearance that differentiates the container from non-compostable alternatives.

According to an embodiment, the pattern comprises wood grain, paper pulp, ridges, corrugations, bamboo, fibers, or paper. These specific patterns evoke natural, biodegradable materials and reinforce the compostable properties of the container.

According to an embodiment, the exterior surface of the cup component comprises a color communicating the compostable property. This color selection provides an immediate visual indicator to consumers that the container is suitable for composting.

According to an embodiment, the color comprises brown, green, beige, or an earth tone. These natural colors are associated with environmental friendliness and composting, facilitating proper disposal by consumers.

According to an embodiment, the filter component stores a beverage base. This storage function maintains the beverage material in a contained space during brewing while allowing liquid to pass through.

According to an embodiment, the beverage base comprises coffee grounds, tea leaves, or cocoa powder. This versatility allows the container to be used with various types of hot beverages in single-serve brewing systems.

According to an embodiment, the single-serve beverage container further comprises at least one post extending inward from an inner surface of the bottom of the cup component. These posts facilitate stacking of empty containers during manufacturing, handling, and shipping while reducing friction and vacuum forces between adjacent containers to provide ease of separation.

### BRIEF DESCRIPTION OF THE DRAWINGS

FIG. 1 depicts a three-dimensional view of a compostable single-serve beverage container in accordance with some embodiments of the present disclosure.

FIG. 2 depicts a top view of the compostable single-serve beverage container in accordance with some embodiments of the present disclosure.

FIG. 3 depicts a bottom view of the compostable single-serve beverage container in accordance with some embodiments of the present disclosure.

FIG. 4 depicts a perspective view of the various components of the compostable single-serve beverage container in accordance with some embodiments of the present disclosure.

FIG. 5 depicts an exploded side view of the compostable single-serve beverage container in accordance with some embodiments of the present disclosure.

FIG. 6 depicts an exploded top view of the compostable single-serve beverage container in accordance with some embodiments of the present disclosure.

FIG. 7 depicts an exploded bottom view of the compostable single-serve beverage container in accordance with some embodiments of the present disclosure.

FIG. 8 depicts a cut-away perspective view of the compostable single-serve beverage container in accordance with some embodiments of the present disclosure.

FIG. 9 depicts a cut-away side view of the compostable single-serve beverage container in accordance with some embodiments of the present disclosure.

FIG. 10 depicts a close-up exterior view of an exterior surface of the compostable single-serve beverage container in accordance with some embodiments of the present disclosure.

FIG. 11 depicts a close-up exterior view of an exterior surface of the compostable single-serve beverage container in accordance with some embodiments of the present disclosure.

FIG. 12 depicts a cut-away view of a multi-layer compostable single-serve beverage container in accordance with some embodiments of the present disclosure.

FIG. 13 depicts a side cut-away view of stacked compostable single-serve beverage containers in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

In some embodiments, the disclosed single-serve beverage container is constructed of compostable materials, in particular, home compostable materials. According to such embodiments, the exterior of the container is colored and textured to convey the home-compostable nature of the container. Visual and/or textural features (e.g., color, patterns, finishes, etc.) are imparted into the external surface of the container to convey that the container is home compostable. In some embodiments, suitable colors may include, for example and without limitation, brown, green, beige, or other earth tones. Suitable patterns may include, for example and without limitation, wood grain, paper pulp, ridges, corrugations, bamboo, fibers, paper, etc. Suitable examples of finishes may include, without limitation, satin finish, dull finish, scuffed/distressed finish, unfinished wood, matte finish, textured finish (e.g., powdered, clay, dirt, etc.), tints (e.g., earthen toned tints), etc. In such embodiments, these visible and textural or tactile features communicate the compostable properties or nature of the underlying container.

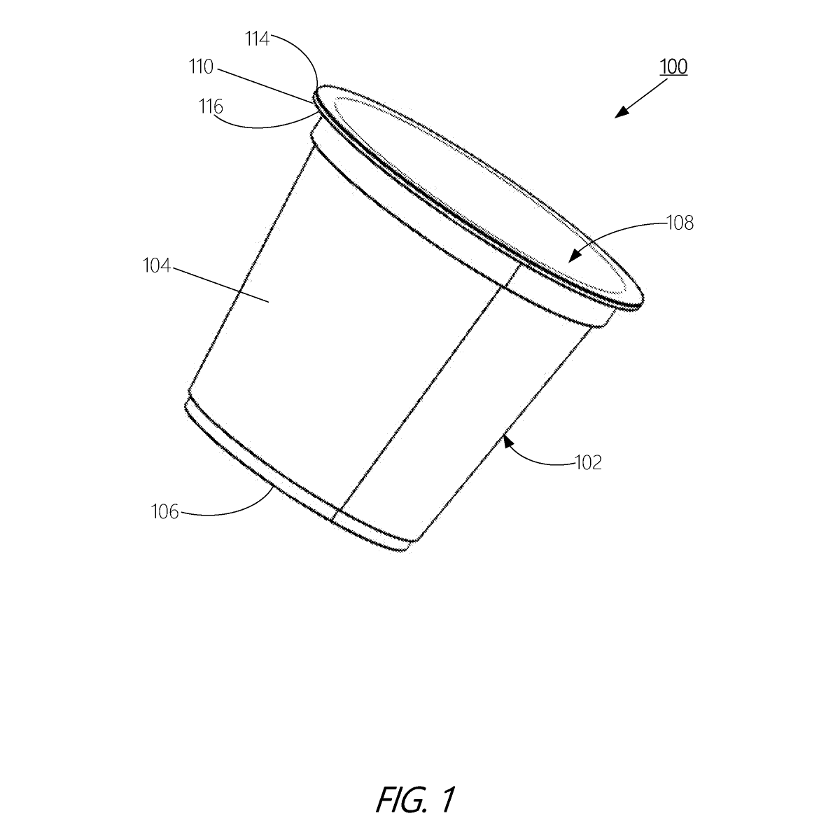

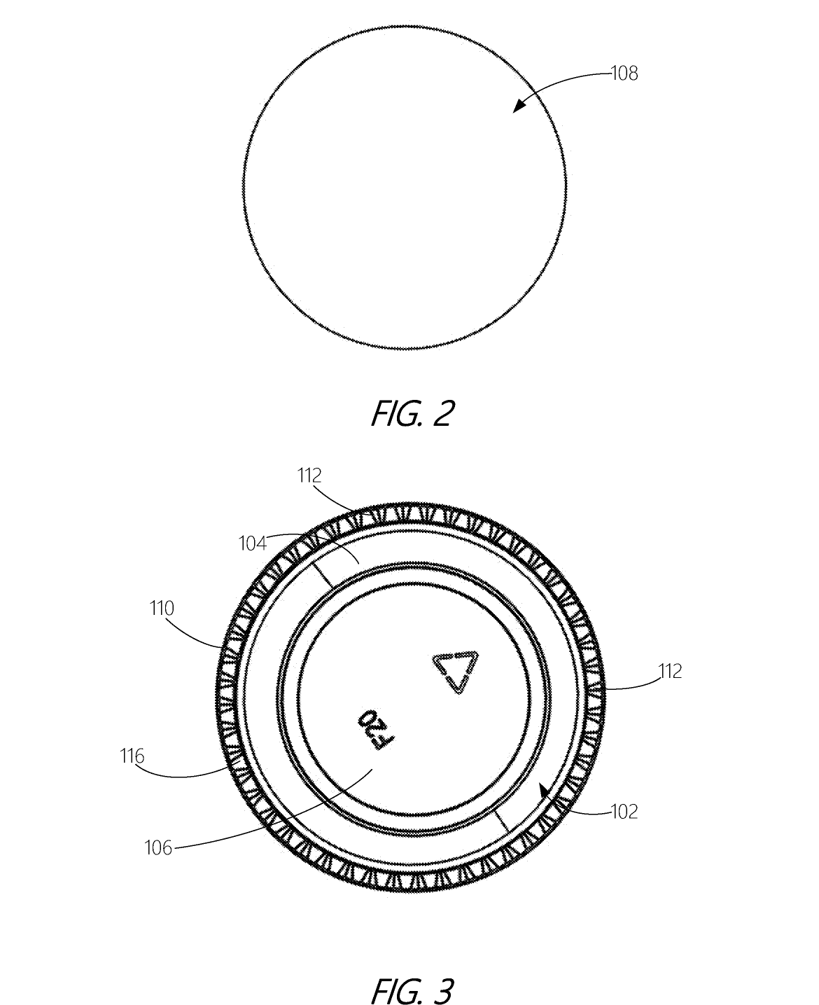

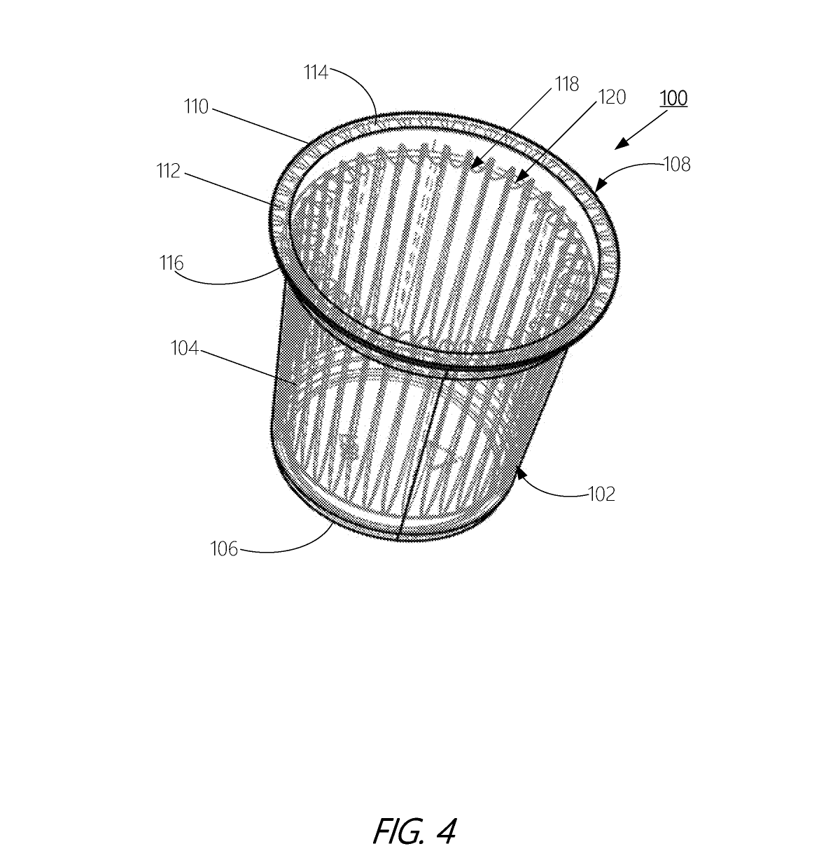

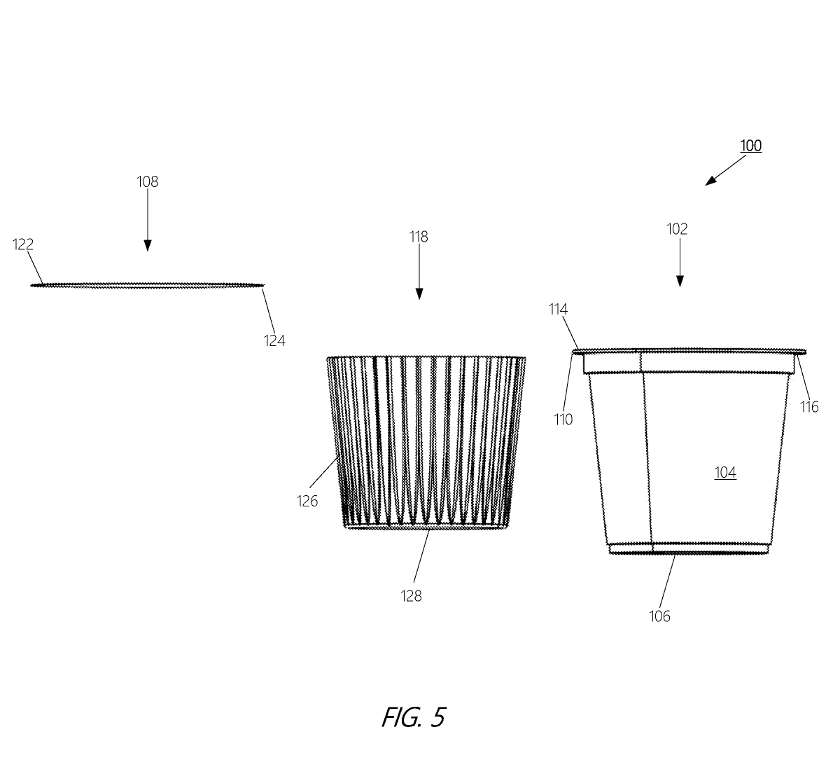

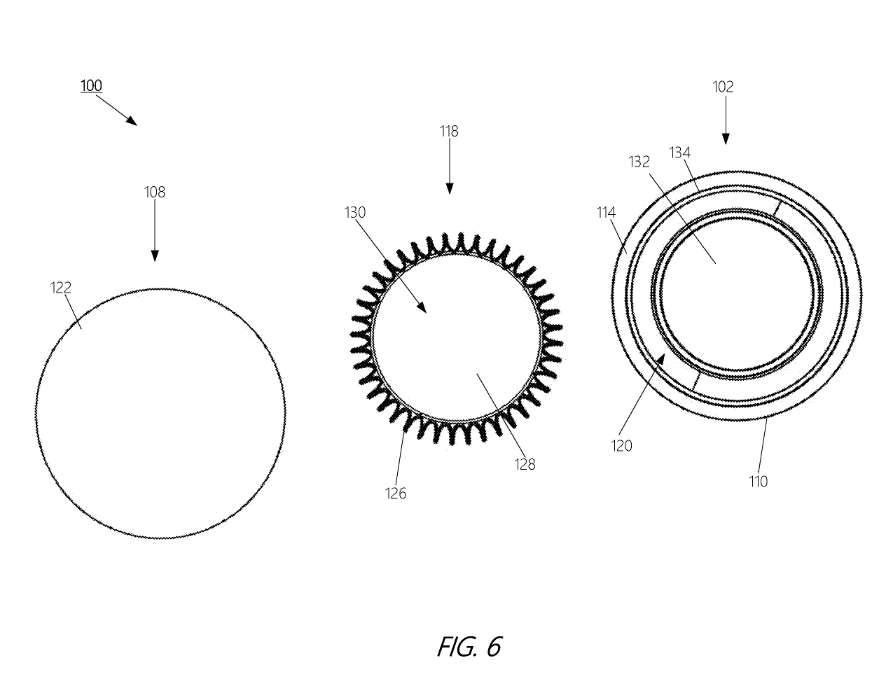

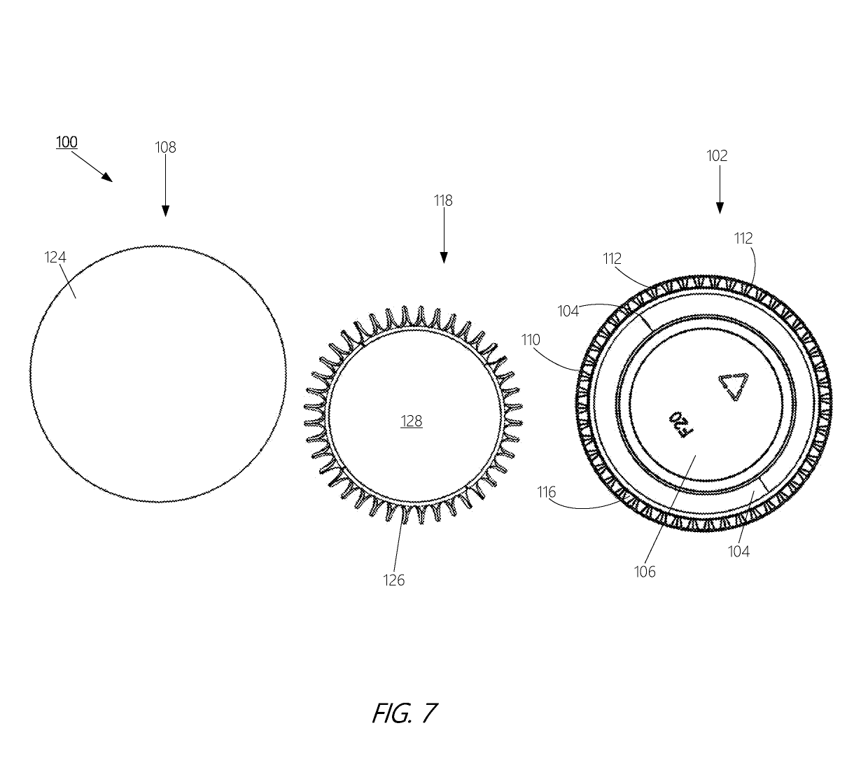

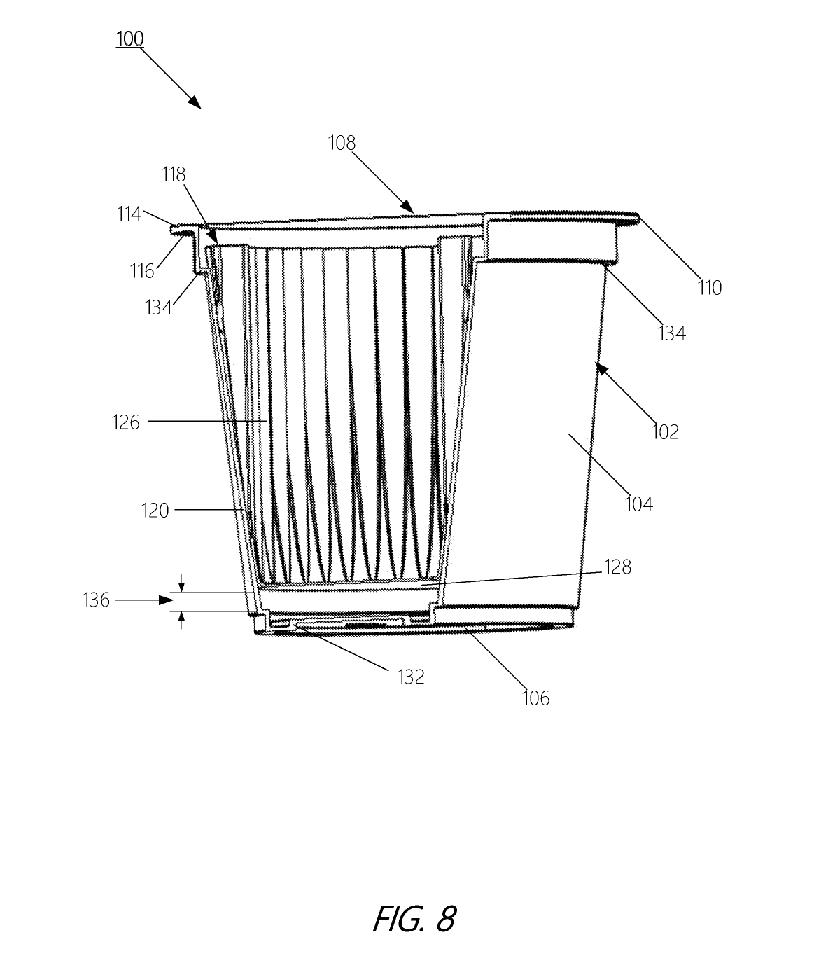

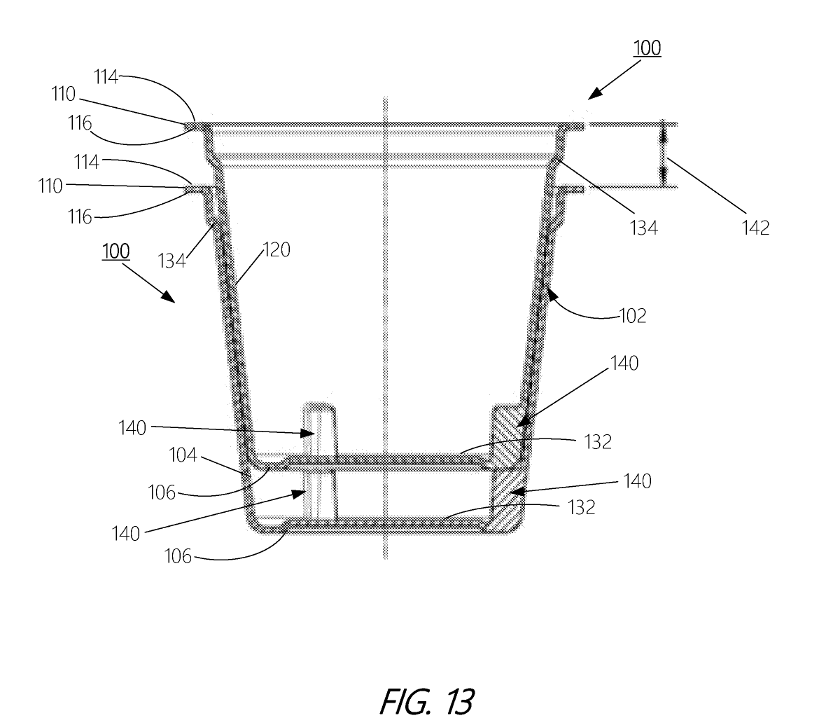

Turning now to FIGS. 1-3, there is shown a compostable single-serve beverage container 100 in accordance with some embodiments of the present disclosure. FIG. 1 provides a perspective view of the container 100, whereas FIG. 2 provides a top view of the container 100 and FIG. 3 provides a bottom view of the container 100 in accordance with some embodiments of the present disclosure. The single-serve beverage container 100 includes a cup component 102 having an exterior side surface 104 and bottom surface 106, and a top cover 108. In accordance with some embodiments, the cup component 102 may be fabricated of a single walled construction (see, e.g., FIGS. 1-11) or a multi-walled construction (see, e.g., FIG. 12). As shown in FIGS. 1-3, the general shape of the container 100 is suitably configured to be inserted into an appropriate beverage brewing system, including, for example and without limitation, KEURIG-branded beverage systems.

The cup component 102 illustrated in FIGS. 1-3 includes a rim 110 disposed on an opposing, open end of the cup component 102 relative to the bottom surface 106. That is, as shown in FIGS. 1-3, the rim 110 is located distally from the bottom surface 106 of the cup component 102 and includes a substantially planar, e.g., flat, upper surface 114 that extends radially outward from the exterior surface 104 of the cup component 102. As shown in FIG. 3, the rim 110 of the cup component 102 may include one or more ridges 112, which may provide additional structural support to the cup component 102, provide structural support to the top cover 108, facilitate the joining of two or more layers of material used in forming the cup component 102, or the like. In accordance with some embodiments, the rim 110 is positioned circumferentially around the top of the cup component 102 and extends perpendicularly outward from the surface 104. As shown in FIGS. 1-3, the rim 110 may include the upper surface 114 and a lower surface 116 (on which the aforementioned ridges are formed). According to some embodiments, the upper surface 114 is suitably smooth and configured to engage a corresponding circumferential portion of the top cover 108 so as to secure the top cover 108 to the cup component 102. Suitable compostable adhesives, heat bonding, or combinations thereof, may be used to secure the top cover 108 to the upper surface 114 of the rim 110.

As indicated above, the single-serve beverage container 100, according to some embodiments disclosed and contemplated herein, may be constructed of compostable materials. For example and without limitation, the cup component 102 may be constructed of a biodegradable compostable plastic material, biodegradable paper material, bioplastic compostable material, and/or combinations thereof. In some embodiments, the cup component 102 may be constructed of a polymeric material, e.g., plastic, capable of being biodegraded or decomposed via natural processes, e.g., microbial action, into water, carbon dioxide, and biomass. Suitable nonlimiting examples of such plastic materials include, without limitation, BioPBS FD92 resin, BWC BF 90A resin, Ecopond Flex 162 resin, HCPT-1 triple laminate, HCFD-2 duplex laminate, Torise TRBF90 resin, or other such material meeting home composting requirements.

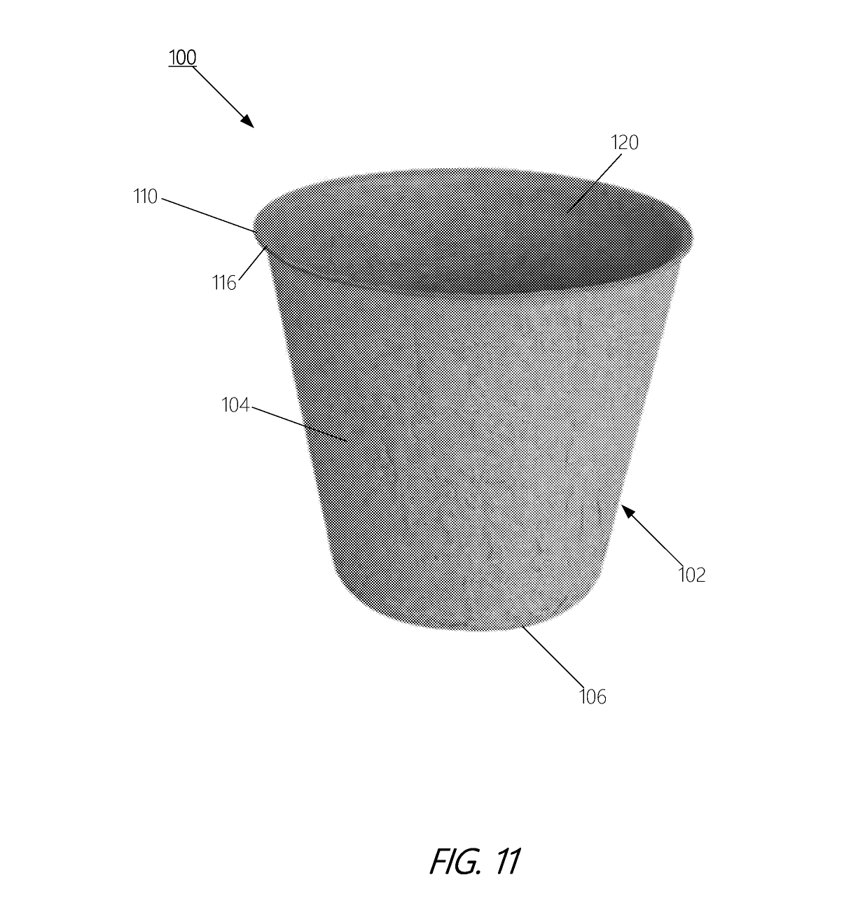

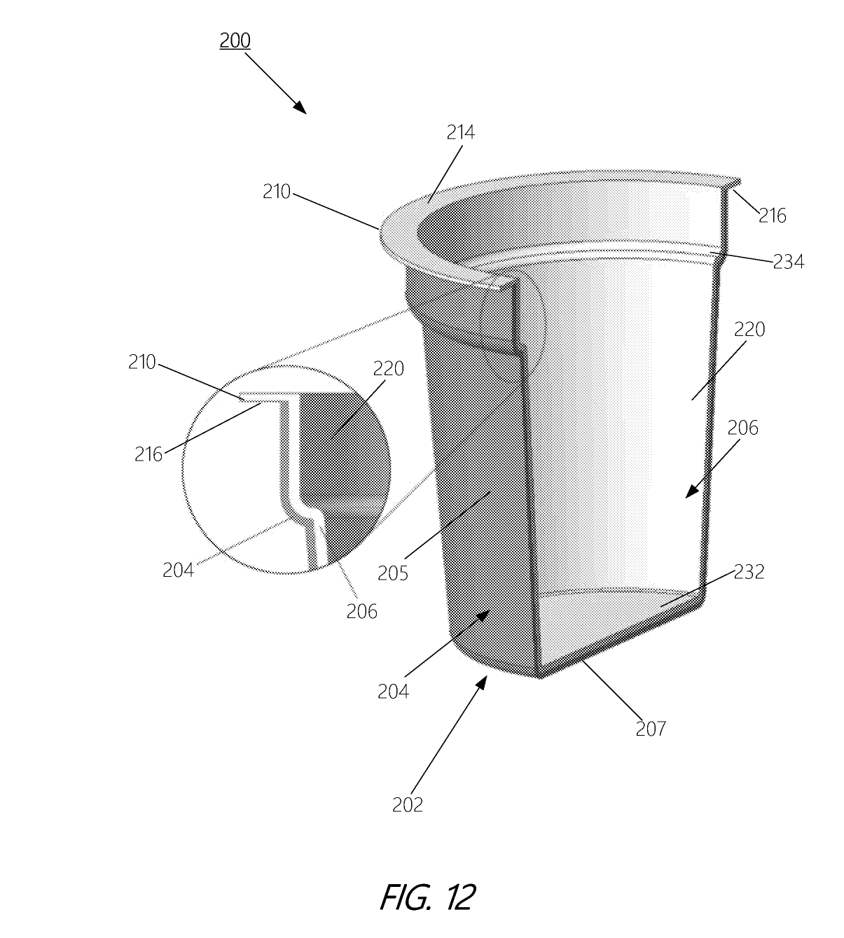

In accordance with some embodiments, the cup component 102 may be constructed of paper-pulp with an oxygen-barrier material applied to protect the beverage base, e.g., coffee ground, tea leaves, cocoa powder, etc., from degradation. As illustrated in FIGS. 10-11, the exterior surface 106 of the cup component 102 provides a visual communication of the compostable property or nature of the single-serve beverage container 100. In some embodiments, the color of the cup component 102 alone or in conjunction with the texture of the surface 106 corresponds to visual cues associated with green, biodegradable, environmentally friendly, compostable, etc., characteristics. Although illustrated in FIGS. 1-3 as having smooth exterior and interior surfaces 104, 120, the cup component 102 may be constructed with braces, gussets, and/or ribs, to strengthen the cup component 102 while reducing the thickness of the material used to form the cup component 102.

Manufacturing of the cup component 102 may be used to impart the aforementioned visual indicators of compostability. In some embodiments, the cup component 102 may be constructed using a suitable mold onto which the material of the cup component 102 is formed, e.g., dip molding, vacuum molding, injection molding, etc. In some embodiments, the mold may include the visual indicators configured to convey the compostable properties or nature of the beverage container 100. By way of example and without limitation, such visual indicators may be imparted through molds or tooling configured to form raised, recessed, embossed, debossed, or molded-in textural features. In still other embodiments, other types of cues, e.g., textual or symbolic indicia, may be imparted directly into the exterior surface of the cup component during fabrication. In other embodiments, the material from which the cup component 102 is constructed may include compostable pigments or dyes providing an additional visual cue as to the compostable properties of the beverage container 100.

Hermetically sealed to the rim 110 of the cup component 102 is a top cover 108. In accordance with some embodiments, the top cover 108 is generally circular in area and configured to seal against the rim 110 of the cup component, securing the beverage base and oxygen-deficient atmosphere within the interior of the cup component 102. The top cover 108 illustrated in FIGS. 1-3 may be constructed of a suitable material providing a variety of functions to the beverage container 100, e.g., retention of atmosphere and contents. Such materials may include compostable materials, such as, for example and without limitation cornstarch, potato starch, sugarcane, bagasse, wood pulp, etc., alone or in combination with a compostable oxygen barrier.

Turning now to FIGS. 4-11, there are shown expanded views of the various components of the single-serve beverage container 100 of FIGS. 1-3. As depicted in FIG. 4, the interior of the cup component 102 may include a separate filter component 118 configured to hold a predetermined amount of beverage base, e.g., coffee grounds, freeze dried coffee, freeze dried tea, freeze dried cocoa, tea leaves, cocoa powder, other freeze dried beverage bases, etc. In accordance with some embodiments, the filter 118 may be affixed or attached to an interior surface 120 of the cup component 102, as shown in FIG. 4. The filter component 118 may be constructed of polymeric biodegradable, e.g., home compostable materials, including a polylactic acid/paper fiber mix, cellulose material (e.g., known coffee filter material), with one or more optional coatings to assist in home composting. Additional details regarding the filter component 118 are discussed below with respect to FIGS. 5-7.

Referring now to FIG. 5, with continuing reference to FIGS. 1-4, there is shown a side or front exploded view of the single-serve beverage container 100 in accordance with some embodiments disclosed and contemplated herein. As illustrated in FIG. 5, the container 100 may comprise three main components, e.g., the top cover 108, the filter component 118, and the cup component 102. The top cover 108, as briefly discussed above, includes a top surface 122 and a bottom surface 124. According to some embodiments, the top cover 108 may be of multilayer construction, such that the top surface 122 may be constructed of a paper (compostable) material configured to receive printing, imaging, etc., thereon to indicate the type of beverage contained therein, the manufacturer or brand thereof, instructions for use, instructions for composting, or the like. In such embodiments, it will be appreciated that the inks or markings disposed on the top surface 122 are also compostable, biodegradable, environmentally safe, and/or food safe. In such embodiments, the bottom surface 124 may be constructed of a suitable oxygen barrier material, configured to retain the internal atmosphere (e.g., freshness) of the contents of the cup component 102. The bottom surface 124 may be constructed of a suitable compostable material that meets food storage requirements, as will be appreciated by those skilled in the art. Suitable examples of such materials include, for example and without limitation cornstarch, potato starch, sugarcane, bagasse, wood pulp, etc., alone or in combination with a compostable oxygen barrier.

In a multilayered construction, the top cover 108 may utilize thermal, adhesive, pressure, or any combination thereof to bond the top surface 122 to the bottom surface 124 to form the top cover 108. In accordance with either the multilayer or single layer construction, the top cover 108 is suitably configured to maintain the freshness of the product stored within the cup component 102, resist unintentional puncturing during packaging, shipping, be home compostable, and function to be pierced during the beverage brewing process, as discussed above. As shown in FIGS. 1-4 and addressed above, an outer periphery of the top cover 108 is configured to adhere, bond, or otherwise seal onto the rim 110 of the cup component 102.

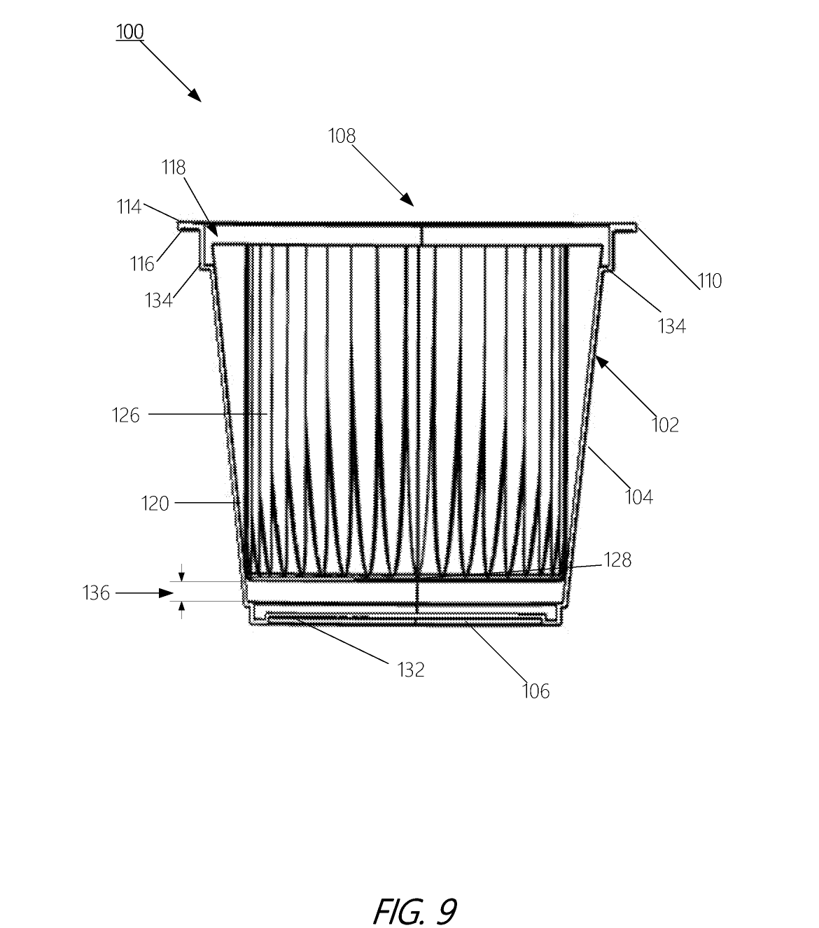

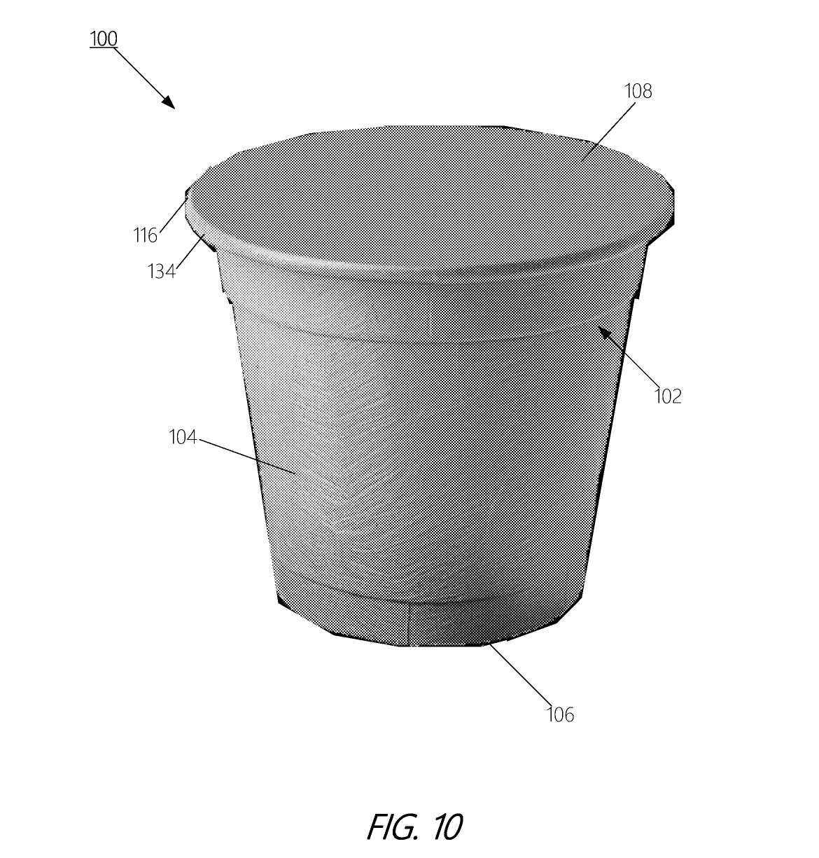

The filter component 118, as illustrated more fully in FIGS. 5-7, includes a ribbed wall 126 and bottom 128 located distally from an open end 130 of the filter component adjacent the rim 110 and top cover 108 (as shown in FIG. 4). As will be appreciated, the ribbed wall 126, e.g., pleats, of the filter component 118 may provide expansion of the filter component 118 during brewing operations, as well as to be complementary to the conical shape of the filter component 118 to fit within the cup component 102. In accordance with some embodiments, the top portion of the filter component 118 proximal to the opening 130 may be configured to engage a top portion of the interior wall 120 of the cup component 102, e.g., thermally bonded, adhesively bonded, etc., thereto, so as to enable the filter component to be positioned a predetermined distance above an interior surface 132 of the bottom 106 (as shown more fully in FIGS. 8-9).

In other embodiments, the top portion of the filter component 118, e.g., the opening 130, may be configured to engage the top surface 114 of the rim 110 of the cup component 102, so as to secure the position of the filter component 118 within the interior of the cup component 102 via adhesive, thermal bonding, etc., thereby providing a predetermined distance 136 between the bottom 128 of the filter component 118 and the bottom 106 of the cup component 102. In accordance with some embodiments disclosed and contemplated herein, the filter component 118 may be suitably sized to allow for attachment to the interior wall 120 of the cup component 102 at a position below the rim 110 relative to the bottom surface 132. As shown in FIGS. 5-7, the cup component 102 may include an interior ledge 134 on which or above which the top portion of the filter component 118 proximal to the opening 130 may adhere, bond, or be otherwise secured, thereby providing the aforementioned predetermined distance 136 between the bottom 128 of the filter component 118 and the bottom 106 of the cup component 102. As shown in FIGS. 5-7, the ledge 134 may be positioned circumferentially on the interior surface 120 of the cup component 102 between the rim 110 and the bottom surface 106 of the cup component 102. It will be appreciated, as discussed above, that such distance provides a buffer area between where the bottom 106 of the cup component 102 is punctured by the beverage system during operations thereof.

FIGS. 8-9 provide cutaway or cross-sectioned views of the single-serve beverage container 100 in accordance with some embodiments disclosed and contemplated herein. In particular, the various components, e.g., the cup component 102, the filter component 118, the top cover 108, etc., are illustrated in the assembled beverage container 100. As shown in FIGS. 8-9, the predetermined distance 136 between the bottom surface 128 of the filter component 118 and the interior surface 132 of the bottom 106 of the cup component 102 is readily visible. As noted above, the predetermined distance 136, e.g., gap, between the filter component 118 and the bottom 106 provides an area into which a needle of the beverage system (not shown) may puncture the bottom 106, but not contact or damage the filter component 118. Accordingly, as the top cover 108 is punctured and steam or water is injected into the cup container, the water or steam percolates through the beverage material (e.g., coffee grounds, tea leaves, etc.), exiting through the filter component 118 to the gap 136 and out of the single-serve beverage container 100 to a vessel, e.g., mug, cup, etc.

The filter component 118 of the single-serve beverage container 100, as depicted in FIGS. 8-9, may be bonded or otherwise affixed proximate to the ledge 134 of the cup component 102. In some embodiments, the filter component 118 may extend perpendicularly upward relative to the ledge 134 towards the top cover 108, as illustrated in FIG. 8. In such embodiments, the filter component 118 may be affixed to the interior wall 120 of the cup component 102 below the ledge 134, allowing for the top of the filter component 118 to extend radially outward on a top surface of the ledge 134, e.g., during manufacture, when saturated with steam/water during brewing, etc. It will be appreciated that such positioning and attachment of the filter component 118 may facilitate the prevention of coffee grounds, tea leaves, cocoa powder, or other beverage base from exiting the filter component 118 down the sides of the interior wall 120 to enter the gap 136 and potentially exit into the drinking vessel during brewing operations.

Turning now to FIG. 10, there is shown an external view of the single-serve beverage container 100 utilizing one type of external visual and textural cues to communicate a compostable property of the container 100 in accordance with some embodiments disclosed and contemplated herein. As illustrated in FIG. 10, the external surface 104 includes a matte finished texture with a “natural” color, e.g., no additives or additional coloring, conveying a compostable suggestion. In some embodiments, the color may correspond to a brown or earthen tone color. In other embodiments, the color may correspond to a paper-pulp or tan color. Other colors synonymous with composting may also be used to contribute to the visual communication of the compostable nature of the single-serve beverage container 100. In some embodiments, the texture may correspond to ridges, raised grains, bumps, etc., evoking a natural or unfinished appearance. In some embodiments, such texture may be imparted to the exterior surface 104 of the cup component 102 during the molding or fabrication of the cup component 102, e.g., formed in the mold or the like. In some embodiments, the exterior surface 104 may additionally or alternatively include explicit compostability indicia, including written text or symbols readable by a consumer prior to disposal, the indicia being configured to directly communicate the compostable nature of the container.

FIG. 11 provides a view of an exterior surface 104 of the cup component 102 in accordance with another embodiment of the single-serve beverage container 100 disclosed and contemplated herein. As shown in FIG. 11, the exterior surface 104 of the cup component 102 includes a finished texture conveying a pulp or paper-like appearance configured to present a visual cue as to the compostable properties of the single-serve beverage container 100. In some embodiments, the exterior and/or interior of the cup component 102 may comprise a corrugated or composite-like appearance, evoking the compostable properties of the container 100. In some alternate embodiments, additional cues may be supplemented with textual or symbolic compostability markings formed in or on the exterior surface 104, which may be tactile, visual, or both.

In some embodiments, the visual cues may be present on the interior surface 120 of the cup component 102 as well as the exterior surface 104. Such visual cues, e.g., texture, color, finish, etc., may only be present on the exterior surface 104, with the interior surface 120 comprising a compostable coating or sealant as an oxygen barrier. As shown in FIGS. 10-11, the bottom surface 106 may also include the same or similar visual cues indicative of compostability referenced above with respect to the exterior surface 104. Variations on the textures, colors, features and/or finishes are contemplated herein, and the examples presented above are intended solely as non-limiting examples of such textures, colors, finishes, and/or features.

With reference now to FIG. 12, there is shown a cut-away view of a single-serve compostable beverage container 200 in accordance with one or more embodiments disclosed and contemplated herein. The embodiment illustrated in FIG. 12 utilizes a multi-layer cup component 202 having a first, outer layer 204 and a second, inner layer 206. As shown in FIG. 12, the outer layer 204 of the multi-layer cup component 202 includes an exterior surface 205, having one or more of colors, textures, finishes, etc., configured to visually and/or texturally convey the compostable property or properties of the container 200. The inner layer 206 of the cup component 202 includes an inner surface 220 comprised of an oxygen-barrier material formed on or adjacent to the outer layer 204. In accordance with some embodiments, the general shape of the single-serve multi-layer beverage container 200 is suitably configured to inserted into an associated beverage brewing system, e.g., a KEURIG-branded, NESPRESSO-branded, etc.

As depicted in FIG. 12, the cup component 202 includes a rim 110 located on an open end of the cup component 202 opposite a bottom surface 207. In some embodiments, the rim 110 is coincident with the inner layer 206 and formed integrally therewith. As shown in FIG. 12, the rim 110 extends circumferentially around the top of the cup component 202, perpendicularly outward relative to the outer layer 204. In accordance with some embodiments, the rim 110 may be configured with additional support structures similar to the ridges 112 described above with respect to FIGS. 1-9. As shown in FIG. 12, the rim 110 comprises an upper surface 214 and a lower surface 216. The upper surface 214 may be fabricated to have a substantially smooth planar surface configured to engage a top cover (not shown) to seal the contents within the cup component 202. Suitable compostable adhesives, heat bonding, or combinations thereof, may be used to secure such a top cover to the upper surface 214 of the rim 210. As illustrated in FIG. 12, the outer layer 204 of the cup component 202 may extend to contact the lower surface 216 of the rim 210. In other embodiments, the outer layer 204 may extend along the lower surface 216 terminating at the edge of the rim 214. Further embodiments contemplated herein may have the outer layer 204 terminate below the lower surface 216, encase the entirety of the rim 210, extend partially inward on the upper surface 214, or the like.

As indicated above, the single-serve beverage container 200, according to some embodiments disclosed and contemplated herein, may be constructed of compostable materials. For example and without limitation, outer layer 204 and the inner layer 206 of the cup component 202 may be constructed of biodegradable compostable plastic materials, biodegradable paper materials, bioplastic compostable materials, and/or combinations thereof. According to some embodiments disclosed and contemplated herein, the outer layer 204 and the inner layer 206 may be constructed of the same or different compostable materials. In some embodiments, the outer layer 204 and/or the inner layer 206 of the cup component 202 may be constructed of a polymeric material, e.g., plastic, capable of being biodegraded or decomposed via natural processes, e.g., microbial action, into water, carbon dioxide, and biomass. Suitable nonlimiting examples of such plastic materials include, without limitation, BioPBS FD92 resin, BWC BF 90A resin, Ecopond Flex 162 resin, HCPT-1 triple laminate, HCFD-2 duplex laminate, Torise TRBF90 resin, or other such material meeting home composting requirements.

In accordance with some embodiments, the cup component 202 may be constructed with the outer layer 204 comprising paper-pulp and the inner layer 206 comprising an oxygen-barrier material to protect the beverage base, e.g., coffee ground, tea leaves, cocoa powder, etc., from degradation. In other embodiments, the construction of the layers 204, 206 may be reversed, such that the outer layer 204 comprises an oxygen-barrier material and the inner layer 206 comprises a paper-pulp. It will further be appreciated that while shown in FIG. 12 as being constructed of two layers, the cup component 202 may be constructed of more than two layers, e.g., three, four, five, etc., layers of the same or different materials. In such embodiments, each of the additional layers may be constructed of the same or different materials, with each having the compostability features and construction described herein.

As illustrated in FIG. 12, the exterior surface 205 of the cup component 202 provides a visual communication of the compostable nature or properties of the single-serve beverage container 200. In some embodiments, the color of the cup component 202 alone or in conjunction with the texture of the surface 205 corresponds to visual cues associated with green, biodegradable, environmentally friendly, compostable, etc., characteristics. Although illustrated in FIG. 12 as having smooth exterior and interior surfaces 205, 220, the cup component 202 may be constructed with braces, gussets, and/or ribs, to strengthen the cup component 202 while reducing the thickness of the material used to form the outer layer 204 and/or inner layer 206 of cup component 202. In some alternative embodiments, the exterior surface 205 of the outer layer 204 may include written, symbolic, or graphical indicia explicitly identifying the container as compostable, the indicia being distinct from branding or product identification, embossed, formed, printed, or otherwise viewable thereon. Such indicia may be integrally formed with the outer layer 204 or applied thereto using compostable inks, pigments, or coatings.

The outer layer 204 and the inner layer 206 of the cup component 202 may be manufactured separately and joined subsequently together, or may be manufactured sequentially, e.g., the outer layer 204 is formed and the inner layer 206 is formed therein, or the inner layer 206 is formed and the outer layer 204 is formed thereon. As noted above, fabrication of the outer layer 204 and/or the inner layer 206 may be used to impart one or more visual and/or textural indicators of compostability. For example and without limitation, the outer layer 204 and/or the inner layer 206 of the cup component 202 may be constructed using a suitable mold onto which the material of one or both of the layers 204, 206 of the cup component 202 are formed, e.g., dip molding, vacuum molding, injection molding, etc. In some embodiments, the mold may include the visual indicators configured to communicate the compostable properties of the beverage container 200. In other embodiments, the material from which the outer layer 204 and/or the inner layer 206 of the cup component 202 are constructed may include compostable pigments or dyes providing an additional visual cue as to the compostable properties of the beverage container 200. In still other embodiments, the outer layer 204 and/or the inner layer 206 may be sprayed onto a mold or to each other to fabricate the cup component 202.

For example and without limitation, the exterior surface 205 of the outer layer 204 may be similar to the surface 104 shown in FIGS. 10 and 11. That is, the exterior surface 205 may include a matte or satin finished texture with a “natural” color, e.g., no additives or additional coloring, conveying a compostable suggestion. In some embodiments, the color may correspond to a brown or earthen tone color. In other embodiments, the color may correspond to a paper-pulp or tan color. Other colors synonymous with composting may also be used to contribute to the visual communication of the compostable nature or properties of the single-serve beverage container 100. In some embodiments, the texture may correspond to ridges, raised grains, fibers, pulp, paper-like corrugations, bumps, etc., evoking a natural or unfinished appearance. In some embodiments, such texture may be imparted to the exterior surface 205 of the outer layer 204 of the cup component 202 during the molding or fabrication, e.g., formed in the mold or the like. Variations on the textures, colors, features and/or finishes are contemplated herein, and the examples presented above are intended solely as non-limiting examples of such textures, colors, finishes, and/or features.

The single-serve multi-layer beverage container 200 shown in FIG. 12 may further utilize a filter component (not shown) configured to hold a predetermined amount of coffee grounds, tea leaves, cocoa powder, drink mix, etc., or other suitable beverage base. As noted above with respect to FIGS. 1-11, such a filter may be affixed or attached to the interior surface 220 of the inner layer 206 within the cup component 202. Suitable materials for such a filter may include, for example and without limitation, a polymeric biodegradable material, e.g., home compostable materials, including a polylactic acid/paper fiber mix, cellulose material (e.g., known coffee filter material), with one or more optional coatings to assist in home composting. In some embodiments, the filter component may include pleats to allow for expansion of the filter component during brewing operations, as well as to facilitate ease of manufacturing the filter component to enable the filter component to be complementary to the conical shape of the interior of the cup component 202.

A top portion of such a filter component may be configured to engage a top portion of the interior surface 220 of the inner layer 206 of the cup component 202, e.g., thermally bonded, adhesively bonded, etc., thereto, so as to allow the filter component to be positioned a predetermined distance above an interior surface 232 of the bottom 207. In other embodiments, an opening of such a filter component adjacent to the top portion thereof, may be configured to engage the top surface 214 of the rim 210 of the cup component 202, thereby securing the position of the filter component within the interior of the cup component 202 via adhesive, thermal bonding, etc., to provide the aforementioned predetermined distance between the bottom of the filter component and the bottom 207 of the cup component 202. In accordance with some embodiments disclosed and contemplated herein, an exemplary filter component may be suitably sized to allow for attachment to the interior surface 220 of the inner layer 206 of the cup component 202 at a position below the rim 210 relative to the bottom surface 232. In some embodiments, the cup component 202 may include an interior ledge 234 on which or above which the top portion of a filter component may adhere, bond, or be otherwise secured, providing the predetermined distance between the bottom of the filter component and the bottom 207 of the cup component 202. It will be appreciated, as discussed above, that such distance provides a buffer area between where the bottom 207 of the cup component 202 is punctured by the beverage system and the bottom of the filter component during brewing.

According to some embodiments, the aforementioned filter (not shown) may be bonded or otherwise attached in proximity to the ledge 234 shown in FIG. 12. Such a filter may be affixed to the interior surface 220 below the ledge 234, affixed to the interior surface 220 such that a top of the filter is coplanar with the ledge 234, or attached to interior surface 220 and extend above the ledge 234. Such positioning, as discussed above, provides a suitable gap, i.e., the aforementioned predetermined distance, between the bottom of the filter and the inner surface 232 of the bottom 207 of the cup component 202. It will be appreciated that such positioning and attachment of the filter may facilitate the prevention of coffee grounds, tea leaves, cocoa powder, or other beverage base from exiting the filter down the sides of the interior surface 220 to enter the gap and potentially exit into the drinking vessel during brewing operations.

Turning now to FIG. 13, there is shown a cut-away side view of stacked compostable single-serve beverage containers 100 in accordance with some embodiments disclosed and contemplated herein. As illustrated, each cup component 102 includes one or more upwardly extending posts, ridges or studs 140 formed on an interior surface 132 of the bottom 106 of the cup component 102. In the illustrated embodiment, three such posts, ridges or studs 140 are provided, spaced circumferentially about the interior surface 132. It will be appreciated that while shown in FIG. 13 as three ridges or studs 140, fewer or more than three posts, ridges or studs 140 may be utilized without departing from the spirit and scope of the present disclosure, e.g., two, four, five, etc., posts, ridges or studs 140 may be formed extending upward from the surface 132 of the bottom of the containers 100.

The posts, ridges or studs 140 extend upwardly from the interior surface 132 of the bottom 106 and are configured to engage a corresponding interior region of an adjacent cup component 102 when multiple containers 100 are nested or stacked, as shown in FIG. 13. In this manner, the posts, ridges or studs 140 facilitate stacking of empty containers 100 during manufacturing, handling, and shipping, while also reducing friction and vacuum forces between adjacent containers to provide ease of separation.

As further shown in FIG. 13, a distance 142 is defined between corresponding rims 110 of adjacent stacked containers 100. The distance 142 is established, at least in part, by the interaction between the posts, ridges or studs 140 and the interior geometry of the stacked containers 100, and is configured to prevent excessive nesting of the cup components 102. In some embodiments, the distance 142 is in a range of about 5 mm to about 11 mm, and in some example embodiments is about 8 mm. This spacing assists in maintaining structural integrity of the containers 100 during stacking and promotes efficient denesting during automated or manual handling operations.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

We claim:

1. A single-serve beverage container, comprising:
a cup component comprising a compostable material, the cup component having an exterior surface, a bottom, and an opening located distally from the bottom;
a filter component having an opening and a bottom surface, the filter component comprising a compostable material positioned within the cup component, the bottom surface located proximal to the bottom of the cup component; and
a top cover affixed to the cup component adjacent to the opening, the top cover comprising a compostable material, and
wherein the exterior surface of the cup component comprises at least one of a visual or textural feature communicating a compostable property of the single-use beverage container.

2. The single-serve beverage container of claim 1, wherein the cup component further comprises an outer layer and at least one inner layer.

3. The single-serve beverage container of claim 2, wherein the outer layer comprises a first biodegradable material and the at least one inner layer comprises a second biodegradable material different from the first biodegradable material.

4. The single-serve beverage container of claim 3, wherein the outer layer and the at least one inner layer are home compostable.

5. The single-serve beverage container of claim 3, wherein the second biodegradable material is an oxygen-barrier.

6. The single-serve beverage container of claim 1, wherein the cup component further comprises a rim located distally from the bottom of the cup component, the rim having a substantially planar surface extending radially outward from the exterior surface of the cup component.

7. The single-serve beverage container of claim 6, wherein the top cover is circumferentially affixed to a top surface of the rim.

8. The single-serve beverage container of claim 7, wherein the rim further comprises a lower surface having at least one ridge formed thereon.

9. The single-serve beverage container of claim 6, wherein the cup component further comprises a ledge positioned circumferentially on the interior surface of the cup component between the rim and the bottom surface of the cup component.

10. The single-serve beverage container of claim 9, wherein the filter component is affixed to the interior surface of the cup component below the ledge.

11. The single-serve beverage container of claim 9, wherein the filter component is affixed to the interior surface of the cup component above the ledge.

12. The single-serve beverage container of claim 1, wherein the compostable material of the cup component comprises at least one of BioPBS FD92 resin, BWC BF 90A resin, Ecopond Flex 162 resin, HCPT-1 triple laminate, HCFD-2 duplex laminate, or Torise TRBF90 resin.

13. The single-serve beverage container of claim 1, wherein the compostable material of the cup component comprises at least one of a biodegradable bioplastic material, a biodegradable plastic material, a biodegradable paper material, or a biodegradable plant-based material.

14. The single-serve beverage container of claim 1, wherein the bottom surface of the filter component is positioned a predetermined distance from the bottom of the cup component.

15. The single-serve beverage container of claim 14, wherein the predetermined distance forms a gap between the filter component and the bottom of the cup component.

16. The single-serve beverage container of claim 1, wherein the exterior surface of the cup component comprises a matte finish, a satin finish, a dull finish, a distressed finish, or a scuffed finish.

17. The single-serve beverage container of claim 1, wherein the exterior surface of the cup component comprises a textured pattern.

18. The single-serve beverage container of claim 17, wherein the pattern comprises wood grain, paper pulp, ridges, corrugations, bamboo, fibers, or paper.

19. The single-serve beverage container of claim 1, wherein the exterior surface of the cup component comprises a color communicating the compostable property.

20. The single-serve beverage container of claim 19, wherein the color comprises brown, green, beige, or an earth tone.

21. The single-serve beverage container of claim 1, wherein the filter component stores a beverage base.

22. The single-serve beverage container of claim 21, wherein the beverage base comprises coffee grounds, tea leaves, or cocoa powder.

23. The single-serve beverage container of claim 1, further comprising at least one post extending inward from an inner surface of the bottom of the cup component.
